(19) United States
(12) Patent Application Publication
(10) Pub. No.: US 2007/0244910 A1
(43) Pub. Date: Oct. 18, 2007

(54) BUSINESS PROCESS META-MODEL

(75) Inventors: Vijay Mital, Sammamish, WA (US); Wolfgang Werner Hilpert, Dossenheim (DE); Chandrika G. Shankarnarayan, Seattle, WA (US); Gueorgui B. Chkodrov, Redmond, WA (US); Gregory Robert Prickril, Redmond, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/279,542

(22) Filed: Apr. 12, 2006

(51) Int. Cl. G06F 7/00

(52) U.S. Cl. 707/100

(57) ABSTRACT

A meta-model representing a business process. Operative expressions are defined for identifying the business process. The business process includes a plurality of activity sequences. Metadata is collected associated with the defined operative expressions. The collected metadata is formatted according to a schema. The meta-model representing the business process is provided to a user as a function of the formatted metadata and the defined operative expressions such that the user can interact with the business process using the defined operative expressions.

### BACKGROUND

Typically, computer software or applications configured for processing business transactions are designed from a software developer's point of view, leaving the business users unable to fully use the software or applications. For example, in a workflow or process-oriented application, a business user may wish to define a workflow which involves a series of process steps, a sequence for the steps, and the roles (e.g., individuals) assigned to perform these process steps. The business user frequently needs to express the idea of the workflow to the developers who can translate these concepts into programming codes before the business user may satisfactorily define the workflow.

It is common that the developers, while designing such applications, place certain restrictions or conditions that are outside of the business user's point of view. For example, in defining the process steps, the developers need to identify data associated with the process steps and how to connect the data from the source so the data can be used during the process step. This may involve data transformations, detailed data connection control and data flow, output data, etc. The developers may also need to consider exceptions, such as when a piece of data is unavailable or a role is unable to complete the assigned task. A further exemplary condition may be that a step in the sequence may trigger security or authentication mechanisms, hardware configuration or settings, etc.

A common problem of today's practice and available software tools is that the conversion between a business level presentation and the developer's level of presentation is achieved by translation—a process that merely converts and maintains the common and overlapping aspects between the two different representations. The translation process, however, loses details of the process design from the developer's perspective. Detailed aspects that have been provided on one level of abstraction (usually, the developer's level) are neglected during the conversion to a different level of abstraction (usually, the business user's level). In addition, changes made on one level of abstraction frequently break refinements that had been made on a different abstraction level. As such, developers and the business users alike need to redefine existing configurations just to recover what has already existed.

As such, the business user, while being able to define the workflow using the tools or functions available to him/her in the current process-oriented applications, lacks the ability to truly identify and interact with the data and operations available in defining a business process across levels of abstractions.

### SUMMARY

Embodiments of the invention overcome the shortcomings of existing approaches by accurately capturing the business intent during a business process design stage. Aspects of the invention providing consistent and efficient ways to transform the process design view between the different levels of abstraction. By defining a set of vocabularies or a set of universal operative expressions, embodiments of the invention bridge the gap between expressed business intent and the implementation and IT configuration of business applications.

Alternative embodiments of the inventions construct or establish a business process meta-model or interface which not only enables a business user to describe a process at his/her abstraction but also enables an information technology (IT) individual or developer to expose the implementation in terms of the same interface. In yet another embodiment of the invention, the IT developer may use the meta-model of the business processes created by the business person to create an implementation for the business processes. Alternatively, given an existing implementation, embodiments of the invention may discover or expose the existing implementation for the business user's desired process expression using the business process meta-model.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1A is a diagram illustrating an exemplary embodiment of a system for representing a business process according to an embodiment of the invention.

FIG. 1B is a diagram illustrating a meta-model according to an embodiment of the invention.

FIGS. 2A to 2B are block diagrams illustrating representing a business process with associated metadata using the defined vocabulary or operative expressions according to an embodiment of the invention.

FIGS. 3A and 3D are block diagrams illustrating different perspectives of a business process according to an embodiment of the invention.

FIG. 4 is an exemplary flow chart illustrating operation of representing a business process according to an embodiment of the invention.

FIG. 5 is a block diagram illustrating an exemplary computer-readable medium on which aspects of the invention may be stored.

FIG. 6 is a block diagram illustrating one example of a suitable computing system environment in which the invention may be implemented.

FIG. 7 is a diagram illustrating an implementation of an entity-action model with schemas associated with entities and actions according to an embodiment of the invention.

Corresponding reference characters indicate corresponding parts throughout the drawings.

### DETAILED DESCRIPTION

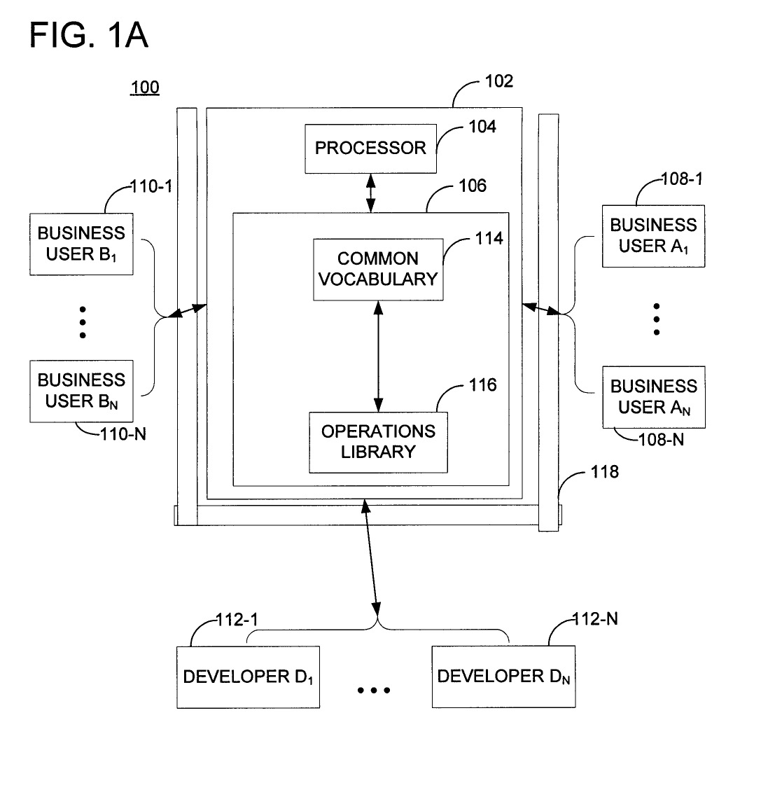

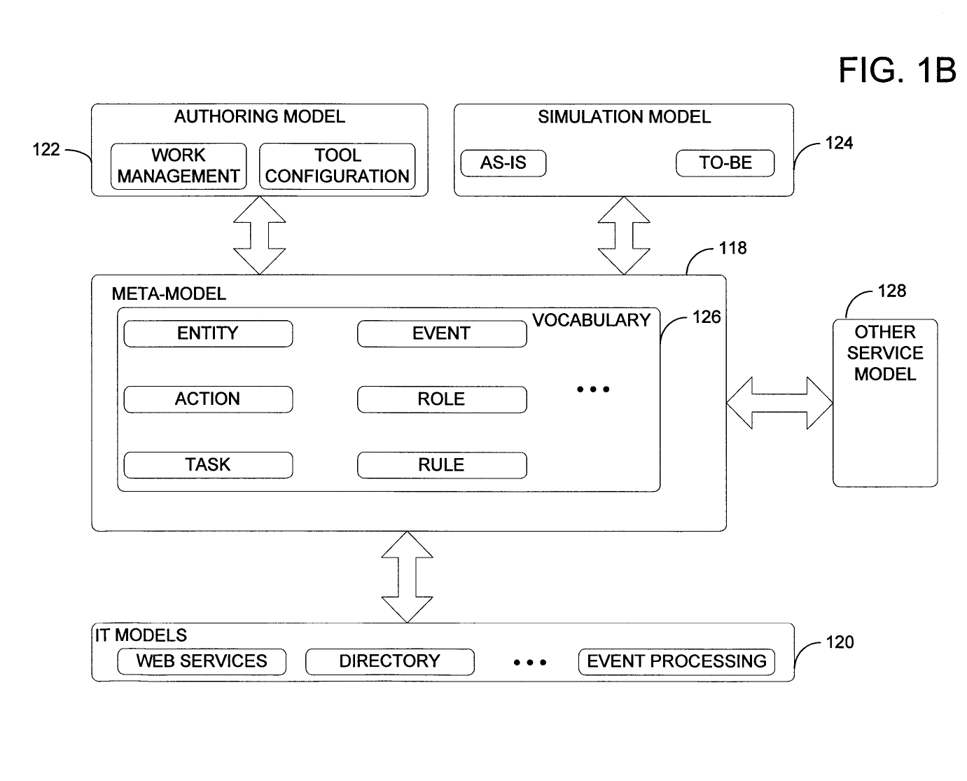

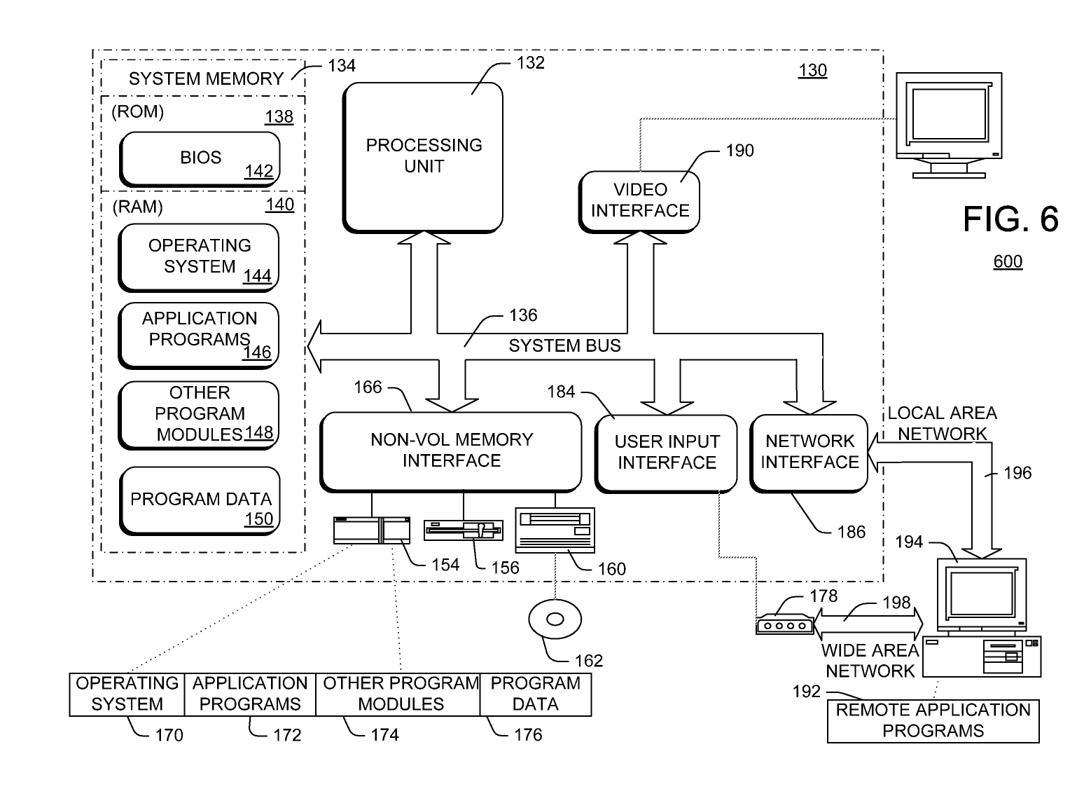

Referring first to FIG. 1A, a block diagram illustrates a system 100 for representing a business process according to an embodiment of the invention. The system 100 includes a general purpose computing device 102, which includes a processor 104 and a memory area 106. In one embodiment, the computing device 102 is a computer 130 as illustrated and described in FIG. 6. The system 100 also includes an interface 118 for collecting data or metadata from a source, which may be in the form of input from a user (e.g., business user 108) or in the form of automated process, such as metadata attached or associated with data when stored in the memory area 106 or another data storage source. In one embodiment, the collected metadata is formatted to a uniform schema, which describes and defines requirements of the metadata. For example, the schema may define that the metadata be within a certain length of characters, or the like. In one embodiment, the system 100 is used to implement a meta-model 118 described in FIG. 1B to represent data or metadata derived from capturing the business intent during business process design stage.

As shown in FIG. 1A, one or more users have access to the computing device 102 in system 100. In one embodiment, the system 100 may be a distributed system with one or more servers and clients configurations with the computing device 102 being one of the servers or clients. For example, one or more business users A_{1-N} 108 have access to the computing device 102, as well as one or more business users B_{1-N} 110. At the same time, one or more developers D_{1-N} 112 are responsible for maintaining, configuring, and designing operations for the business users A_{1-N} 108 and business users B_{1-N} 110. In one example, business users A_{1-N} 108 and business users B_{1-N} 110 may be part of the same business enterprise or may be associated with different businesses.

Referring now to FIG. 1B, the meta-model 118 is built to communicate with an information technology (IT) model 120 on the one hand and with an authoring model 122 and a simulation model 124 on the other. For example, the IT model 120 provides one or more IT implementations, such as web services, directory services, event processing, or the like. The authoring model 122 includes work management implementations, software tools configurations, or the like. The simulation model 124 (to be described further below) includes “as-is” and “to-be” implementations. By using a set of vocabularies 126 defined within the meta-model 118, embodiments of the invention facilitate the communications between the IT model 120, the authoring model 122, and the simulation model 124, and other software models, modules, or components for enhancing representation of user's business intent in designing business processes.

For example, using the vocabularies 126, the IT developers designing the IT model 120 may define functions or operations for other models using the same concept. At the same time, these IT developers may discover and use existing functions or operations (e.g., in the authoring model or simulation model) that are defined using the same set of vocabularies 126. Similarly, the authoring model 122 and the simulation model 124, and other service model 128 may seamlessly communicate with other software models, modules, or components to fully represent the business intent of the user.

It is to be understood that, while only six vocabulary terms are defined within the meta-model 118 as shown in FIG. 1B and illustrated further below, other terms or constructs may be defined so as to capture commonly used concepts in business processes without departing from the scope of the invention.

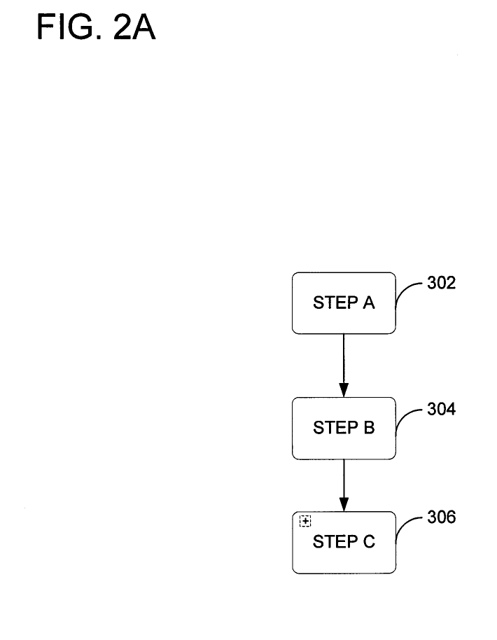

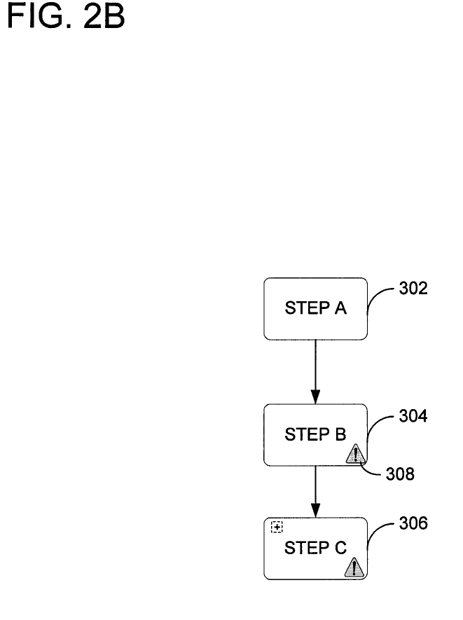

FIGS. 2A and 2B are block diagrams illustrating representing a business process with associated metadata using the defined vocabulary or operative expressions according to an embodiment of the invention. In FIG. 2A, a block diagram illustrates a business user's conception or intention of the business process design. For example, the user (e.g., user 108 in FIG. 1) intends to design a set of business processes with a step A 302, followed by a step B 304 and a step C 306.

FIG. 2B illustrates an initial stage of defining task in a business process (e.g., purchase order). At 302, the step A defines a task that has already been bound to an existing implementation resulting in the absence of any visual cue about an inconsistency. For example, a user_A₁ may be assigned to perform a task of receiving all purchase orders. However, at 304, the step B defines a task which has not been bound to existing operations for its implementation yet. As such, a warning sign 308 indicates such problem. For example, a task of order approval is assigned to a supervisor of user_A₁, but no such role exists yet to perform this task. At 306, a step C represents a composite task. When the user clicks on the ‘+’ sign, the visual representation of the task will be expanded to display the containing processes. For example, in the task of approving an order, the individual who approves the order is required to check the inventory or other tasks. The warning sign also indicates that some elements inside the composite task 306 are not yet bound to an implementation.

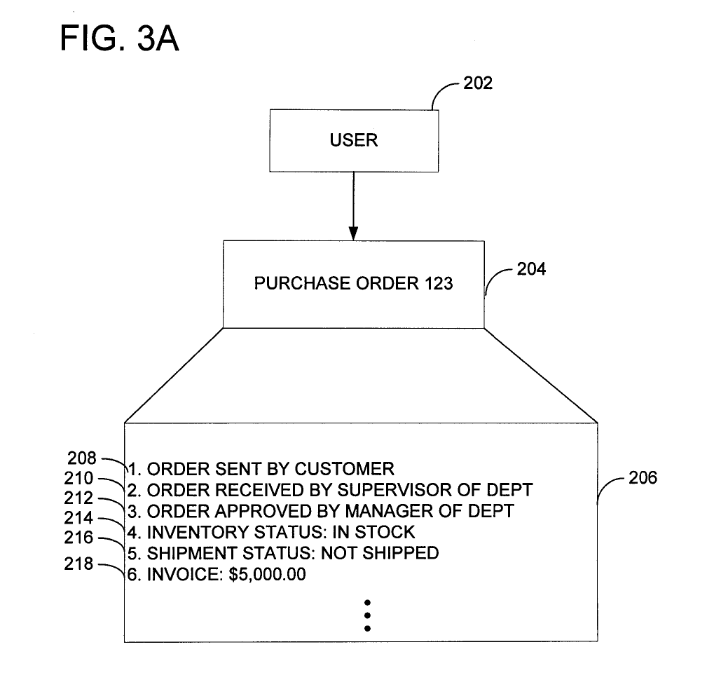

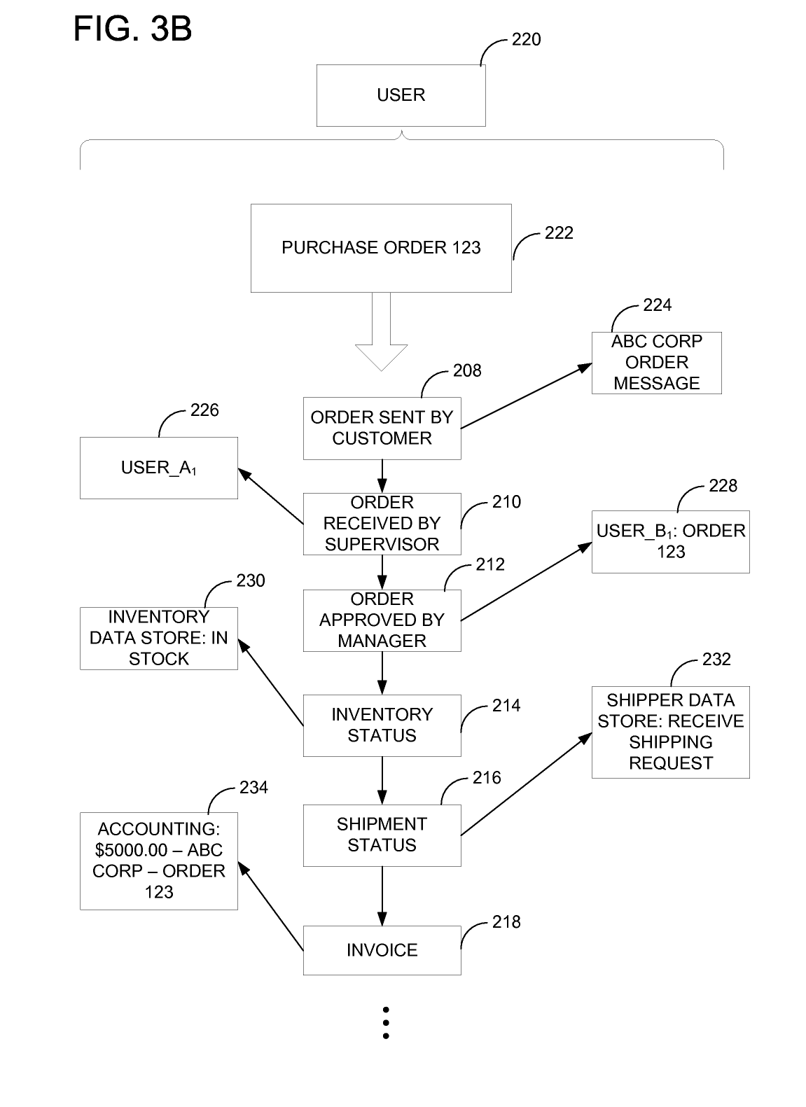

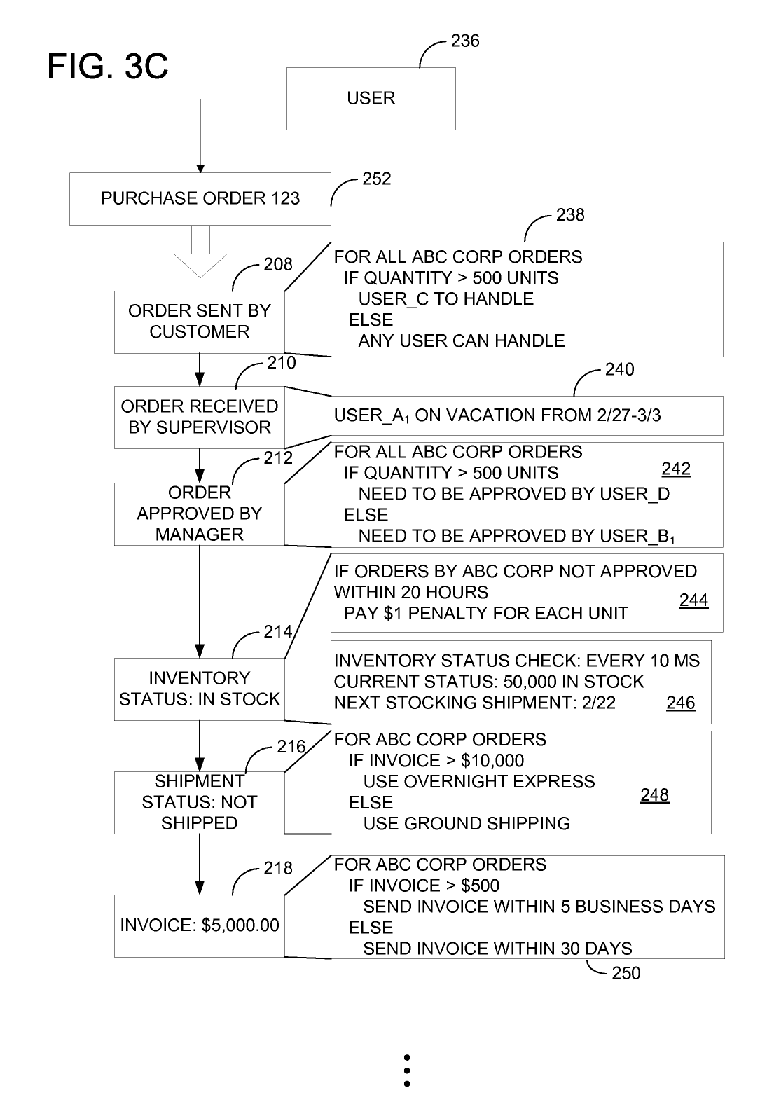

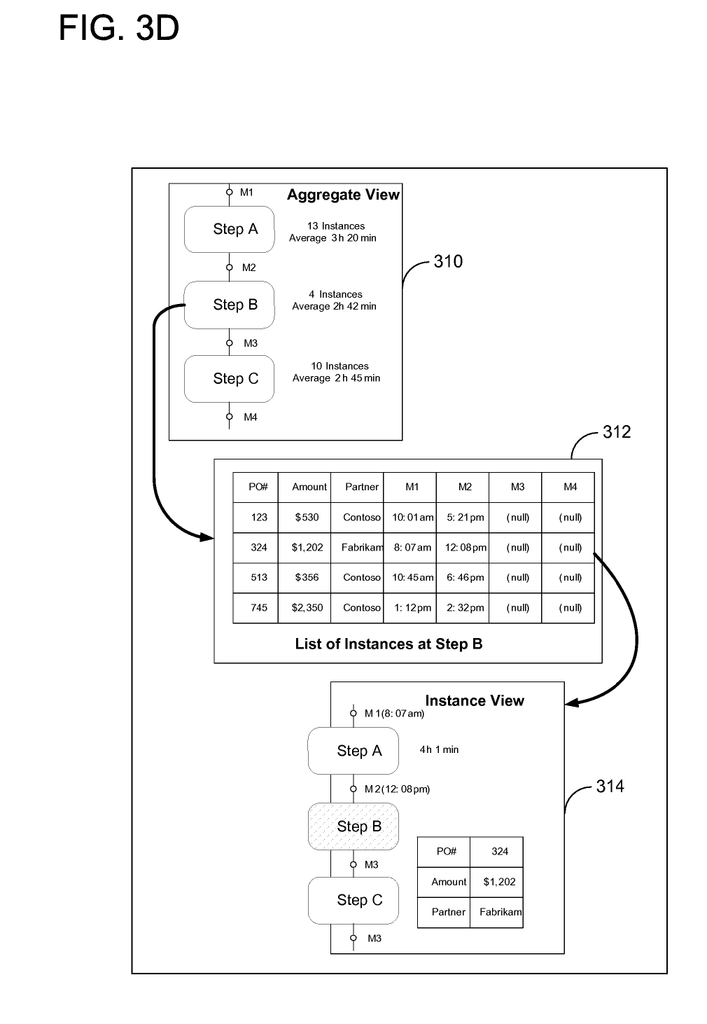

Referring now to FIGS. 3A and 3C, three block diagrams illustrate different user perspectives of a business process according to an embodiment of the invention. FIG. 3A shows a user perspective of a user 202 (e.g., business user A 108). In this example, the user 202 is an individual who is interested in activities and their sequences. In other words, the user 202 may only be interested in the tasks and the sequences of events relating to the business process, such as handling a purchase order, such as purchase order 123, in 204. In this illustration, what the user 202 would view or access is what is provided to the user 202 in a view 206: a list of tasks and a sequence of events that have taken place for the purchase order 123. For example, the view 206 describes that at 208 the purchase order 123 was sent from a customer, such as an ABC Corp. At 210, the purchase order 123 is next received by a supervisor of a sales department. For example, an instance of the supervisor may be USER_A₁. At 212, the purchase order 123 is subsequently approved by a manager of the sales department (e.g., USER_B₁). The next task shown is that at 214 the inventory status is “in stock” and the shipment status for the purchase order 123 is “not shipped” at 216. Also, the view 206 shows at 218 the invoice for the purchase order 123 is “$5,000.00.”

FIG. 3B, on the other hand, illustrates a different view for a user 220, who may be a person who wishes to link activities to data sources, data transformation and data flows. In other words, the user 220 wishes to bind tasks and events to entities. As such, a view 222 of the purchase order 123 presented to user 220 would be different from the view 202 presented to the user 202 in FIG. 3A. For example, in this view 222, for the same order sent by the customer (e.g., ABC Corp.), at 208, the user 220 may have access to a message 224 (e.g., voice mail message, electronic mail (e-mail) message, or the like) which placed the order sent by the ABC Corp. For the order being received by the supervisor (e.g., user_A₁) at 210, the view 222 may show a contact information 226 of the supervisor, such as the phone number, e-mail account, or other contact information of the person. For the order approval at 212, the user 220 may view a contact information 228 of the manager (e.g., user_B₁) in addition to the details of the order 123 at 214. At 216, the view 222 may show a snapshot 232 of the shipper's data store and the status shown at the shipper's data store. At 218, the invoice may have an access to a link 234 to an accounting department's data store with $5,000.00 being associated with the purchase order 123.

FIG. 3C describes a view from a perspective from a user 236 who may be a person who wishes to describe the capabilities of an implementation in terms of entities, so the application can be used in the process, such as exposing entities and actions for use in task sequences. In this example, a view 252 of the purchase order 123 may include one or more of the following, as noted below:

For the same step 208 of the order sent by the customer ABC Corp., the view 252 may show a set of conditions, such as those shown in a box 238. For example, the user 236 may already have a set of conditions to implement this step 208, such as:

For all ABC Corp. orders
{ if quantity > 500 units

V.P. of Sales Department to handle;

else

any user can handle;}

In other words, when the user 236 accesses the same purchase order 123, instead of what is described in FIG. 3A or 3B, the user 236 views a different perspective, which is more technically oriented.

At 210, the order is received by the supervisor, the developer also sees a box 240 indicating that the supervisor (e.g., USER_A₁) is or will be on vacation from 2/27-3/3. As such, the user 236 may implement an automatic response event to be sent to other personnel to handle purchase orders in the absence of the supervisor. At 212, for the order approval by the manager (e.g., USER_B₁), the user 236 may have access to a box 242 which shows another set of restrictions associated with this step:

For all ABC Corp. orders
{ if quantity > 500 units

need to be approved by V.P. of the Sales Department;

else

need to be approved by Manager of the Sales Department;}

In one embodiment, the user 236 may further view (not shown) the detail of actual purchase order 123 to determine whether the purchase order 123 indeed has less than 500 units such that the manager is handling the order correctly. Otherwise, the user 236 may issue an alert event indicating that the V.P. of the Sales Department should have approved the purchase order 123.

At 214, the user 236 may view boxes 244 and 246 to further identify the inventory status. In this example, the user 236 may see the following as an instance of an exemplary inventory status verification implementation:
If orders by ABC Corp. is not approved within 20 hours pay $1 penalty for each unit;
Inventory status check: every 10 ms;
Current status: 50,000 in stock;
Next stocking shipment: 2/22;

In this embodiment, not only may the user 236 view the metadata associated with the conditions of the inventory and this particular customer, the user 236 views the current status of the inventory such that the user 236 may implement an alert event when the inventory is low or the next shipment date has not been identified.

At 216, the user 236 views a box 248 showing the following condition for the shipping status:

For ABC Corp. orders
{ if invoice > $10,000

use overnight express;

else

use ground shipping;}

At 218, the view 252 may expose a box 250 to the developer showing yet an instance of another condition for the invoice to the user 236:

For ABC Corp. orders
{ if invoice > $500

send invoice within 5 business days;

else

send invoice within 30 days;}

It is to be understood that the steps or the conditions/restrictions described in FIGS. 3A to 3C are for illustration purpose only and do not thus limit the scope of the invention. Other properties, sequences, descriptions, parameters, conditions, or the like that may be associated with a business process may be incorporated without departing from the scope of the invention.

As such, depending on the perspectives of a user (e.g., user 202, user 220, or user 236), embodiments of the invention represent a business process meta-model consistently while adapted to the needs to different users. In addition, user 202, user 220, or user 236 can be interchangeably used in each view or perspective so that each can access the different views or perspectives, provided that the user has the right/permission to access or modify metadata associated with the business process.

In achieving such omnipresent representation of the business process, such as placing a purchase order, embodiments of the invention define a common vocabulary 114 or a set of operative expressions by which business-oriented people and IT-oriented individuals may reason over and express business processes in a consistent way. In addition, through the common vocabulary or the operative expressions, business people and IT individuals may preserve, expose, and annotate information meant for the other group or perspectives.

Existing business workflow or process-oriented software applications are often used to manage how different entities along with organizational roles (e.g., persons or individual) interact with various tasks such as in workflow processes. For example, a typical series of purchase order fulfillment workflow process may take place:

1. an order fulfillment clerk may be responsible for receiving the order from a customer;

2. a manager of the customer's region may be in charge of approving the order;

3. an inventory manager may have the duty to identify the availability of the ordered product; and

4. a shipping department manager processes the shipment of orders.

In many instances, any individual in the same role, such as a manager, may perform the task. However, business workflow software applications need to resolve situations where a specific individual of a specific role must perform a particular task. For example, an expression such as “this.customer.region.manager” requires an identification of the individual who is entitled to play the role for a particular workflow instance.

Unlike the existing practice or the existing business-process applications, embodiments of the invention, rather than translating between different levels of abstraction of a business process model, design a collaborative interface with business processes meta-model between business users and IT developers through the introduction of the common vocabulary or operative expressions. This is a collaborative interface because it enables users from various perspectives express the business processes with a consistent, and yet flexible, interface such that the users may fully express a desired operations without losing details of the technical implementations. With this, aspects of the invention describe a production environment or an interface in which business people can create and change process models in order to try things out without the need for constant supervision or assistance from IT developers for implementation of changes to process applications.

Embodiments of the invention define the common vocabulary or operative expressions including the following:

1. Event: a meaningful change of state in any process or service to which the business may respond, where events carry a “payload” to express the state and/or change in terms of entities. For example, an event may be an incoming purchase order request, an alert exception, or the like.

2. Entity: a class of information with a business meaning; an entity has a reference, which is a unique way to refer to an instance of an entity through either an ID or some attribute values. For example, an entity may be a customer ID, which includes a reference such as the name and contact information of a customer.

3. Action: operations to be performed or executed on an entity. For example, operations such as, create, read, update, delete (CRUD), or other actions afforded by an entity. Other actions take a reference to an entity as an input, but cause no-CRUD effects on the referenced entity.

4. Task: a logical unit of work with well-defined beginning and end states that can be assigned to humans or systems. A task can be projected as an entity. A task has a data context that can contain references to a number of entities (see Table 1 for additional detail). For example, a task may be to approve a purchase order.

5. Rule: a declarative expression of a business decision that is evaluated by reference to the state of one or more entities in the scope of the business logic or process in question. Rules can be applied to multiple process artifacts such as events, actions, roles, and tasks.

6. Role: an individual who can perform which tasks or take which Actions. For example, role definitions include references to information such as relationships between personnel and business entities, and entities in the workflow system itself. The example “this task must be approved by the manager of the region in which this customer is situated”, which may be expressed as “this.customer.region.manager”, illustrates that the role resolution requires both the entities known to the workflow (i.e., “this customer”) and the relationships that are known only to personnel and business systems (i.e., what region does this customer reside it, and who is the region manager).

As another example, Table 1 further describes some of the defined vocabulary or operative expressions and its exemplary operations:

TABLE 1
Defined vocabulary or operative expressions and the
interaction within the metadata interface; *Activity
being associated with business activity monitoring.

| Vocabulary/ | | | |
|---|---|---|---|
| operative | | Associated | |
| expression | operations | vocabulary | examples |
| Entity | Decomposes; | Entities; | Entities decompose entities; |
| | exposes | actions | entities expose actions |
| Event | Consumes; | Patterns; | Events consumes patterns, |
| | initiates | processes | events initiates process |
| Action | Returns; | Entities; | Actions return entities; |
| | permissions | roles | actions define role |
| | | | permissions |
| Task | Assigned to; | Roles; data | Tasks assigned to a role; |
| | scopes | context; | tasks are within the scope of |
| | | actions | data context |
| Rule | Applies | Tasks; data | Rules apply to tasks (or |
| | | context | workflow), actions, events, |
| | | | and roles; rules apply to data |
| | | | context |
| Role | Perform; | Tasks; | Roles perform tasks; roles |
| | permissions | activities | are permitted to perform |
| | | | certain activities |
| *Activity | Refers to | Entities | Activities refer to entities; |
| | | | activities use patterns |
| Pattern | Produces | Events | Patterns produce events; |
| | | | patterns is exposed as |
| | | | activities |

Alternatively, embodiments of the invention discover existing operations that are already available to users. For example, in order to get the customer status about a given customer, the processor 104 can easily determine within the operations library 116 whether an action such as ‘get customer status’ is available on an entity ‘customer’ within the operations library 116.

In yet another embodiment, when no existing operation may be identified as satisfying the needs of a user, the user, which may be a business user with no technical knowledge, will be guided by embodiments of the invention through the common vocabulary or operative expressions to provide structured requirements for the IT developer to design the requested operation satisfying the requirements of the business process. Even though, the requested operation in question has not been provided yet, the business user may continue with and complete the process design on the business level.

In the event that the developer has difficulties fulfilling the requested operation's requirements without impacting any other interfaces, the developer may flag the impact of their changes on other design components to the business user in process representation on their level of abstraction.

In yet another alternative embodiment, the business user may modify or extend the business process design by only utilizing existing operations. As such, the business process may be executable without requiring further IT implementation efforts. For example, the processor 104 may receive input from the user (e.g., business user_A₁ in FIG. 1) for executing an operation that is already stored in the operation library 116.

It is also to be understood that various programming languages, routines, codes, or application components may be implemented for constructing the business process meta-model without departing from the scope of the invention. For example, in implementing the vocabulary or operative expression “Entity,” one may use an application component written in C# language for handling all execution of processing entities, such as a user account, a task, or the like. However, embodiments of the invention provide metadata associated with the user account or the task, as well as the data or operations associated therewith, to the user such that users with different perspectives may consistently interact with the entities or data. In yet an alternative embodiment, the vocabulary or operative expression may be extended to add new behavior or expressions based on the customer's organizational methodology requirements. For example, new constructs can be added to the meta-model that complies with the meta-model schemas as described by the embodiments of the invention. Also, existing metadata may be discovered as long as they comply with the meta-model schema dictated or described by the embodiments of the invention.

FIG. 3D is a block diagram illustrating three different views of the business process, such as those shown in FIG. 2A. In particular, FIG. 3D shows a runtime picture of the business process, which includes the three steps: steps A, B, and C. In this embodiment, the collected metadata is correlated with the plurality of activity sequences included in the business process.

For example, in a view 310, which is an aggregate view, shows the current status of the business process. For example, from the collected metadata, there are 13 instances of activities or entities in step A while there are 4 instances of step B. In a separate view 312 (e.g., a drill down view, triggered by input from a user, such as double-click) shows a list of these four running instances as depicted in “List of Instances at Step B”. In such view, the user may interact with the metadata displayed by selecting one of the instances to view further details. In a view 314, the user obtains the “Instance View” of a purchase order #324. This view 314 visually highlights information about this particular instance, such as the current task that this instance is on (here: “Step B”), the start time of any previous, current task, and any subsequent tasks (e.g., step C which is shown in dashed lines as being not completed yet), or the like.

As such, embodiments of the invention correlate the metadata with the activities in the sequence as the instances of the process progress through various milestones (denoted as “M1”, “M2”, or “M3” in FIG. 3D). The correlated metadata includes the time stamp (e.g., 8:07 am at M1, duration (e.g., 4 hours and 1 minute), or the like).

In an alternative embodiment, a report may be generated showing the state of the business process. In another embodiment, the processor 104 may simulate a progress of the business process given a set of collected metadata. For example, the simulated process would confirm that the actual business process would provide the expected result given the collected metadata. For example, simulations may be implemented via “as-is” processes as well as “to-be” processes. “As-is” process simulation results in an understanding of where data is flowing, what actions happen on the data, and what the end result of the process is. This is mostly done to check to ensure the process is doing what was expected to do (meet SLA, KPI goal etc.). Simulating “to-be” processes involves changing steps in the process or data in the process to check for a different end result.

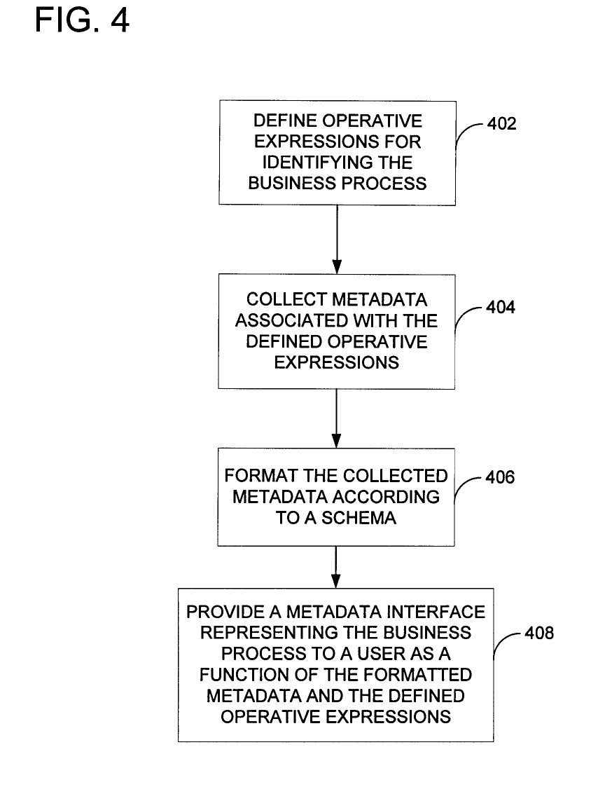

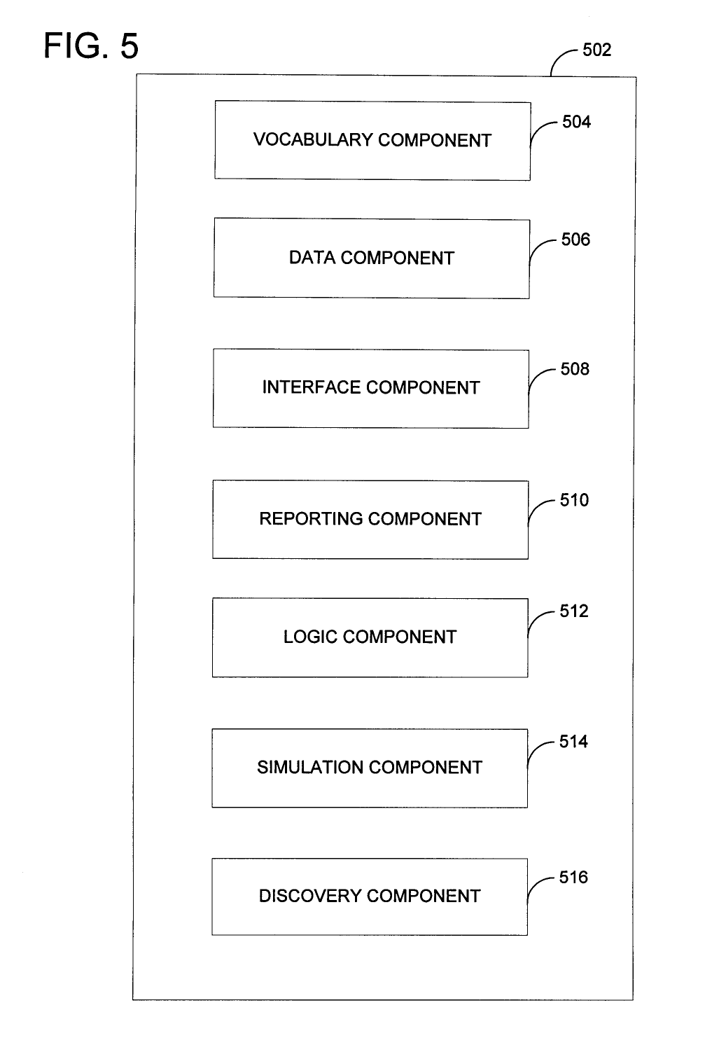

FIG. 4 is a flow diagram illustrating an exemplary method for representing a business process according to an embodiment of the invention. In one example, one or more computer-readable media, such as a computer-readable medium 502 in FIG. 5, includes computer-executable components to implement the method illustrated in FIG. 4.

For example, a vocabulary component 504 may define operative expressions for identifying the business process at 402. The business process includes a plurality of activity sequences. At 404, a data component 506 collects metadata associated with the defined operative expressions. In one embodiment, the collected metadata is formatted according to a schema (not shown) at 406. In one example, the schema includes the metadata in eXtensible Markup Language (XML) format describing the entire business process including entities, entity views, information on actions, etc. In such example, the operative expression “action” may be described using the XML schema as the following:

1. ActionName(Type=“Get”, EntityReference)

2. ActionName(Type=“Put”, EntityReference, PutParameters)

3. ActionName(Type=“Act”, EntityReference, ActParameters)

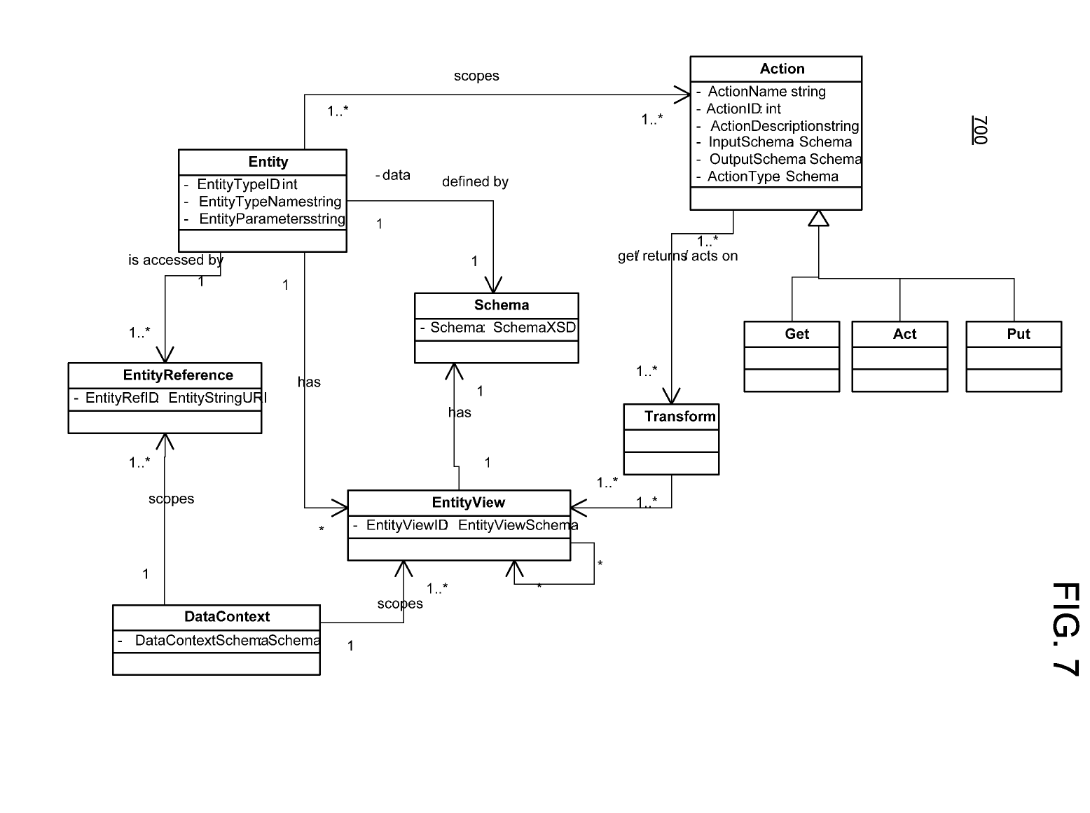

FIG. 7 also describes a diagram illustrating an exemplary implementation of an entity-action model based on a schema 700 of the meta-model according to an embodiment of the invention.

At 408, an interface component 508 provides the collected metadata to a user. In another embodiment, the vocabulary component 504 describes the business process so that the interface component 508 can provide the collected metadata to the user (e.g., business user A 108 or business user B 110) so that the user may manipulate, operate or access the metadata associated with the business process. In one embodiment, a reporting component 510 reports analysis of the described business process to the user. For example, the reporting component 510 may report the progress of the business process.

In an alternative embodiment, a logic component 512 evaluates a set of rules associated with the collected metadata such that the user can interact with the business process. In yet another embodiment, a simulation component 514 simulates the progress of the plurality of activity sequences based on the operative expressions in response to the received input by the interface component. In a further embodiment, a discovery component 516 discovers one or more existing configurations or operations associated with the business process.

FIG. 6 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 6 illustrates operating system 144, application programs 146, other program modules 148, and program data 150.

The computer 130 may also include other removable/non-removable, volatile/nonvolatile computer storage media. For example, FIG. 6 illustrates a hard disk drive 154 that reads from or writes to non-removable, nonvolatile magnetic media. FIG. 6 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 6, provide storage of computer readable instructions, data structures, program modules and other data for the computer 130. In FIG. 6, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 6 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 6 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Aspects of the invention described herein includes these and other various types of computer-readable storage media when such media contain instructions or programs for implementing the steps described below in conjunction with a microprocessor or other data processor. Further, aspects of the invention include the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in the figures (e.g., FIG. 4) to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method for representing a business process, said method comprising:
defining operative expressions for identifying the business process, said business process including a plurality of activity sequences;
collecting metadata associated with the defined operative expressions;
formatting the collected metadata according to a schema; and
providing a meta-model representing the business process to a user as a function of the formatted metadata and the defined operative expressions such that the user can interact with the business process using the defined operative expressions.

2. The method of claim 1, wherein defining operative expressions comprises defining a collection of operations for exposing the business process and the included plurality of activity sequences for manipulation by the user.

3. The method of claim 1, wherein defining operative expressions comprises defining a collection of vocabularies, said collection of vocabularies describing the business process for the user and a developer.

4. The method of claim 1, further comprising generating a report describing a state of the business process, said state defining progress of the plurality of activity sequences as a function of the operative expressions and the collected metadata.

5. The method of claim 4, further comprising, in response to input from the user, simulating the progress of the plurality of activity sequences based on the operative expressions.

6. The method of claim 1, further comprising correlating the collected metadata with the plurality of activity sequences included in the business process.

7. The method of claim 1, wherein providing comprises discovering one or more existing configurations associated with the business process, said existing configurations defining existing operations for interacting with the business process.

8. The method of claim 1, wherein one or more computer-readable media have computer-executable instructions for performing the method of claim 1.

9. A system for describing a business process, said system comprising:
an interface for collecting metadata;
a memory area for storing the collected metadata;
a processor configured for executing computer-executable instructions for:
defining operative expressions for identifying the business process, said business process including a plurality of activity sequences;
associating the collected metadata with the identified business process as a function of the defined operative expressions;
formatting the collected metadata according to a schema; and
providing a meta-model representing the business process via the interface to a user as a function of the formatted metadata and the defined operative expressions such that the user can interact with the business process using the defined operative expressions.

10. The system of claim 9, wherein the processor is configured to define a collection of operations for exposing the business process and the included plurality of activity sequences for manipulation by the user, and wherein the memory area stores information relating to the collection of operations.

11. The system of claim 9, wherein the processor is further configured to generate a report describing a state of the business process, said state defining progress of the plurality of activity sequences as a function of the operative expressions and the collected metadata.

12. The system of claim 11, wherein the processor is further configured, in response to input from the user, simulate the progress of the plurality of activity sequences based on the operative expressions.

13. The system of claim 9, wherein the processor is further configured to correlate the collected metadata with the plurality of activity sequences included in the business process.

14. The system of claim 9, wherein the processor is further configured to discover one or more existing configurations associated with the business process, said existing configurations defining existing operations for interacting with the business process.

15. One or more computer-readable media having computer-executable components for representing business process, said computer-executable components comprising:
a vocabulary component for describing the business process;
a data component for collecting metadata corresponding to the described business process;
an interface component for providing the collected metadata to a user;
a reporting component for reporting analysis of the described business process; and
a logic component for evaluating rules associated with the collected metadata such that the user can interact with the business process.

16. The computer-readable media of claim 15, wherein the vocabulary component comprises defining a collection of operations for exposing the business process and the included plurality of activity sequences for manipulation by the user.

17. The computer-readable media of claim 15, wherein the vocabulary component comprises defining a collection of vocabularies, said collection of vocabularies describing the business process for the user and a developer.

18. The computer-readable media of claim 15, wherein the reporting component generates an analysis report describing a state of the business process, said state defining progress of the plurality of activity sequences as a function of the operative expressions and the collected metadata.

19. The computer-readable media of claim 18, wherein the interface component receives input from the user, and further comprising a simulation component for simulating the progress of the plurality of activity sequences based on the operative expressions in response to the received input by the interface component.

20. The computer-readable media of claim 15, further comprising a discovery component for discovering one or more existing configurations associated with the business process, said existing configurations defining existing operations for interacting with the business process.
